(19) United States
(12) Patent Application Publication
(10) Pub. No.: US 2005/0183743 A1
(43) Pub. Date: Aug. 25, 2005

(54) Method and system for maintaining a solution of a sparingly soluble additive in a process fluid

(75) Inventor: Keith R. Pope, Merrimack, NH (US)

Correspondence Address: MAINE & ASMUS, 100 MAIN STREET, P O BOX 3445, NASHUA, NH, 03061-3445, US

(73) Assignee: S.C. FLUIDS, INC., Nashua, NH (US)

(21) Appl. No.: 11/064,640

(22) Filed: Feb. 24, 2005

Related U.S. Application Data
(60) Provisional application No. 60/547,239, filed on Feb. 24, 2004.

(51) Int. Cl. B08B 3/04

(52) U.S. Cl. 134/18; 134/26; 134/34; 134/107; 134/94.1; 134/100.1; 134/93; 134/113; 134/56 R

(57) ABSTRACT

A method is disclosed for the introduction of at least one additive to a processes chamber, that method comprising: supplying a process fluid to the process chamber; introducing at least one co-solvent to the process fluid thereby forming a mixture of process fluid and co-solvent without the additive; allowing a concentration of the co-solvent relative to the process fluid at least within the process chamber to reach a level at which the sparingly soluble additive is soluble; adding a solution of the additive to the mixture of the process fluid and the co-solvent, and processing a workpiece in the fluid.

### RELATED APPLICATIONS

This application claims the benefit of U.S. Provisional Application No. 60/547,239, filed Feb. 24, 2004. This application is herein incorporated in its entirety by reference.

### FIELD OF THE INVENTION

This invention relates to the cleaning of a workpiece using one or more solvents in the supercritical phase, and more particularly to cleaning processes using additives that are sparingly soluble in the supercritical solvent.

### BACKGROUND OF THE INVENTION

Methods for cleaning photoresist, resin and other contaminates from work pieces, such as semiconductor substrates, microelectromechanical devices (MEMs devices), and masks, are widely known. Also widely known are other supercritical processes. These methods typically involve injecting fluid and additives to the cleaning chamber, and elevating the temperature and pressure to supercritical levels. At these temperatures and pressures, a combination of chemical and mechanical mechanisms perform the necessary work to loosen and remove the unwanted materials, or otherwise process the semiconductor wafer or other workpiece. In such methods, the cleaning fluid mixture may be elevated in temperature and pressure to supercritical state prior to injection into the chamber, or, alternatively, the fluid may be heated from liquid phase to the supercritical phase under pressure in the process chamber.

Other and various systems have been developed employing means for mixing, randomizing, stirring, or otherwise redirecting the flow of the fluid, and are known to those skilled in the art. According to some such systems, additives may be introduced into the fluid to obtain a desired result. Examples of such additives include: surfactants, emulsifiers, detergents, dilutors, extenders, viscosity modifiers, etchers, deposition precursors, nucleating agents, solvents, antistatic agents, builders, foaming or antifoaming agents, or other chemicals necessary to effect a particular process.

While such additives may have desirable characteristics, the additive's solubility and other properties may be unfavorable. In particular, it has been noted that additives added in solution may not remain in solution, may result in other components of the co-solvent package separating or precipitating, or otherwise adversely affecting the properties of the process fluid mixture. In some such cases this phase separation may be irreversible, or the concentration of the additive may never recover to the desired concentration. Carbon dioxide and solutions containing carbon dioxide and other common supercritical fluid solvents tend to be poor solvents of compounds having high permanent dipole moments. This arises in part from the small permanent dipole moment of the carbon dioxide molecule, and thus much of the molecular interaction with solutes occurs through Van der Waals forces, which tend to be orders of magnitude less strong at intermolecular distances than electrostatic or dipole-based interactions.

In order to affect certain kinds of processing in microelectronics fabrication, it is necessary, perhaps unavoidable, to introduce chemical species which feature large permanent dipole moments, because the chemical mechanisms of their action involve the development of charge or extensive charge separation at the molecular interaction site.

An example of a process in which an additive having a high dipole moment is required is the etching of dielectric materials. Such materials cannot be achieved without the separation of charge sufficient to overcome the lattice energy of the dielectric. The etching of dielectric material is frequently employed in the field of microelectronic manufacture, among other uses, providing a useful method for removal of debris, particulates and residue from earlier manufacturing processes. The forgoing leads to the necessity of using polar cosolvents and additives to support many desirable processes.

In typical continuous flow systems, the delivery of the co-solvent package through the system involves the combination of a co-solvent stream, fed by one pump or other feed vector, with the main supercritical fluid stream, the resulting mixture then bringing about a desired mixture of chemicals in the pre-calculated and desired relative concentration as to effect the process in the process chamber. During this mixing and introduction of chemicals the initial concentrations of the various chemicals may be unfavorable, or may pass in gradient through an unfavorable regime en route to the desired relative concentrations. For example, in supercritical fluid processing for microelectronic and other processes, the introduction of additives to the fluid stream will, in many cases, involve the introduction of a more polar additive concentrate to a flowing stream of less polar carbon dioxide. This gives rise to a concentration gradient that extends physically through a fluid from the point of introduction to the point at which fluid contacts the work piece. This concentration gradient may induce the mechanism whereby an additive could precipitate or otherwise separate in phase from the main stream of process fluid. For a brief time the concentration gradient may give rise to contiguous regions of the fluid stream whose composition lies outside the range where the additives are soluble, and thus may give rise to precipitation or phase separation before the desired process can be effected.

In one such process, the Co-solvent/additive solution may be injected into a flow of supercritical fluid upstream from a vessel where the workpiece resides. The instantaneous composition in the vessel may, for a time, be unfavorable to support the continued dissolution of the process additives in the region of the workpiece until the concentration of the co-solvent reaches its steady-state value in the region of the chamber. Thus, for systems that employ continuous flow, in contrast to batch mixing in an accumulation vessel or loop, there will be a kinetic effect that temporarily moves the composition of the fluid to a potentially unstable point in the phase-composition space of the fluid.

Among the deleterious effects of phase separations, residue or particulates of insoluble additives may be deposited on the work piece. In microelectronics even the smallest particle of foreign material can be enough to cause complete functional failure.

What is needed, therefore, are techniques for preventing the separation of additives from the process solution in continuous flow systems.

### BRIEF SUMMARY OF THE INVENTION

One embodiment of the present invention provides a method for the introduction of at least one additive to a process chamber, that method comprising: supplying a process fluid to the process chamber; introducing at least one co-solvent to the process fluid thereby forming a mixture of process fluid and co-solvent without the additive; allowing a concentration of the co-solvent relative to the process fluid at least within the process chamber to reach a level at which the sparingly soluble additive is soluble; adding a solution of the additive to the mixture of the process fluid and the co-solvent, and processing a workpiece in the fluid.

Another embodiment of the present invention provides such a method wherein the additive comprises at least one additive selected from the group consisting of organo-quaternary ammonium halides, organo-quaternary ammonium psuedo halides, acidic aluminum salts, organic salts and inorganic salts. In some cases, ionic liquids may be incorporated into formulations by presaturating with a solvent that provides for better phase control, solubility, or emulsification of the ionic liquid needed to be used, without problematic separation before the desired composition is reached.

A further embodiment of the present invention provides such a method wherein the co-solvent is a low molecular weight hydrocarbon miscible with carbon dioxide.

Yet another embodiment of the present invention provides such a method wherein the co-solvent is at least one hydrocarbon selected from the group of hydrocarbons consisting of methanol, ethanol, isopropanol, Butanol, and other short chain organohydroxy compounds.

A yet further embodiment of the present invention provides such a method wherein the process fluid is selected from the group of process fluids consisting of carbon dioxide, Argon, sulfur hexafluoride, and combinations thereof.

Even another embodiment of the present invention provides such a method wherein the process fluid is a fluid in a supercritical phase.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow chart illustrating known continuous flow treatment method.

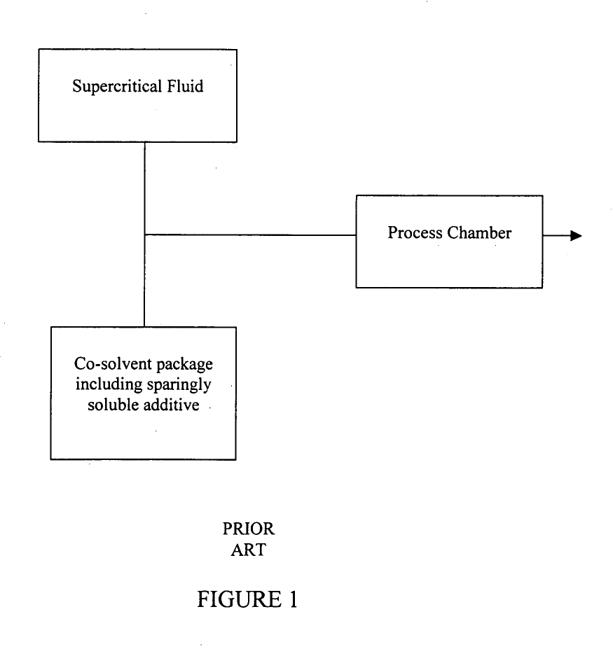

FIG. 2 is a block diagram illustrating a system whereby a co-solvent is introduced to fluid flow and process chamber prior to introduction of additive, according to one embodiment of the present invention.

FIG. 3 is a block diagram illustrating a system having a single point of introduction whereby a co-solvent is introduced to fluid flow and process chamber prior to introduction of additive, according to one embodiment of the present invention.

FIG. 4 is a flow chart illustrating the steps of a method according to one embodiment of the present invention whereby a co-solvent is introduced to fluid flow and process chamber prior to introduction of additive.

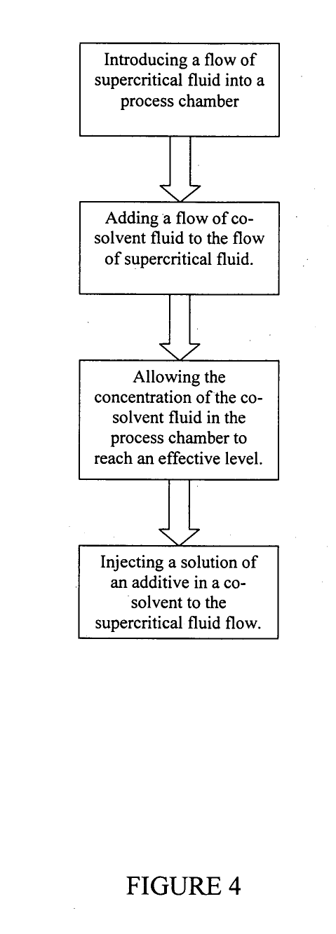

### DETAILED DESCRIPTION OF THE INVENTION

According to one embodiment of the present invention, the precipitation of desired additives may be avoided or ameliorated by presaturation of a supercritical fluid solvent with an effective amount of co-solvent to maintain a desired additive in a dissolved state. The term co-solvent is used herein to denote a solvent or combination of solvents used in conjunction with another solvent to form a process fluid used in the processing of workpieces.

To prevent precipitation or phase separation, the fluid stream composition is, according to one embodiment, treated with an excess of co-solvent. The excess concentration is carefully considered, for it must be such that it will prepare a fluid stream between the point of additive injection through to the workpiece processing environs that will compensate for the kinetically induced transition in fluid phase composition. This compensating advance displacement in the phase-composition space of the fluid is termed “presaturation”. This presaturation step is typically carried out by injection of the solvent component of the co-solution without the insoluble component. This may be effected either by a separate injection of a separate co-fluid, or by the injection of a concentration gradient controlled by the amount ratio between two simultaneously supplied reservoirs, fed to a pumping system capable of gradient elution. Once the additive and co-solvent concentration have increased to a certain point, an excess of co-solvent is no longer necessary and the system continues the process with co-fluid pumped at the steady-state composition. Those skilled in the art of chemical engineering will appreciate that such an approach can be modified to provide a continuously varying fluid composition with time to suit the needs of processing throughout the workpiece process cycle.

In one embodiment, one or more co-solvents are introduced into a supercritical fluid solvent and brought to equilibrium or to a state where the concentration of co-solvent relative to process fluid throughout the process chamber is adequate to prevent the precipitation of the additive. At least one additive that is insoluble or sparingly soluble in the supercritical fluid solvent, such as a salt, liquid ionic compound or other polar compound, is dissolved in a separate supply of at least one co-solvent, that co-solvent being selected for its ability to dissolve the additive. The additive-co-solvent solution is introduced into the co-solvent-supercritical fluid solvent cocktail. The mole fraction of the co-solvent-supercritical fluid solvent cocktail is selected to allow for miscibility with the additive-co-solvent solution, without precipitation of the additive. One of ordinary skill in the art will readily appreciate that the co-solvent carrying the additive may already be present in the co-solvent-supercritical fluid solvent cocktail and that the employment of a pre-saturation phase need not require qualitatively different chemicals to effect the result. Embodiments, however, where different solvents are used would be within the scope of the present invention as well. A stock solution of co-solvent must be provided substantially free of the potentially problematic additive present until such time as the concentration of the co-solvent is high enough to permit the introduction of the additive without substantial precipitation or phase separation.

The method of presaturation greatly expands, both quantitatively and qualitatively, the range of available chemistries for processing applications. It also provides for the processing of a wider range of materials and structures, and facilitates optimization of the process within less restrictive chemical requirements. Such processes, as a result of the use of presaturation, may also incorporate more chemical components into a single fluid cocktail, potentially shortening the necessary time for processing.

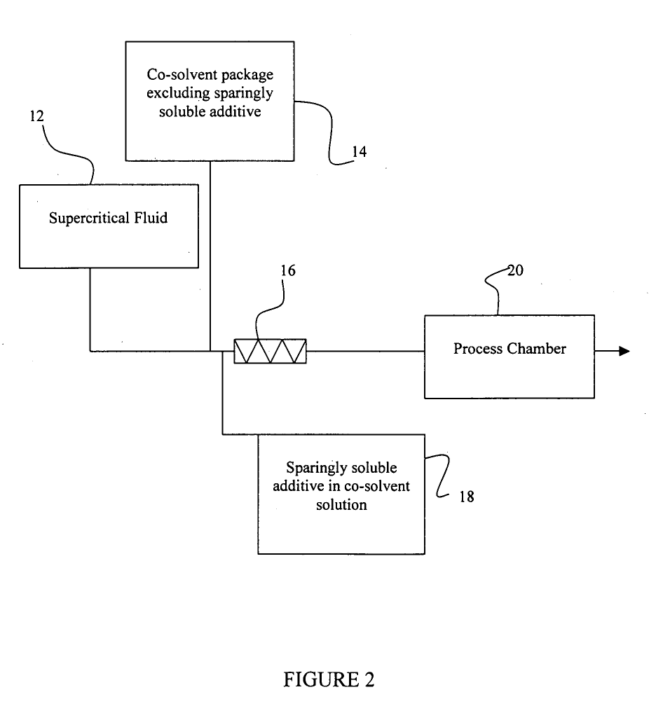

FIG. 2 is a block diagram illustrating one embodiment of the present invention. A supercritical fluid 12 is mixed with a co-solvent package 14 readily miscible with the supercritical fluid 12. According to one embodiment, means for mixing or otherwise facilitating the formation of an equilibrium 16 such as static or active mixers may be provided. The co-solvent package 14 specifically excludes any additives that are sparingly soluble or insoluble in the supercritical fluid. Once a concentration of co-solvent adequate to support the solution of the soluble or insoluble additives is reached throughout the process chamber 20, the sparingly soluble additive 18, in a solution of a co-solvent selected for its ability to dissolve the additive 18, is introduced in to the system. The solution of supercritical fluid 12, co-solvents 14, and additives 18 are then introduced into the process chamber 20. One of ordinary skill in the art will readily appreciate that the sparingly soluble or insoluble additive 18 may be introduced to the fluid flow line at any point from the introduction of co-solvent 14 to the process chamber 20. In the case of highly corrosive additives, some embodiments may introduce the additive 18 within close proximity to the process chamber 20, preventing damage to large sections of the line. In alternative embodiments, the additives may be incorporated at the same or proximate to the point of introduction of the co-solvent package 14. In such embodiments, a single pump may be used, while one skilled in the art would readily appreciate that embodiments wherein a plurality of pumps are utilized would likewise be within the scope of the present invention.

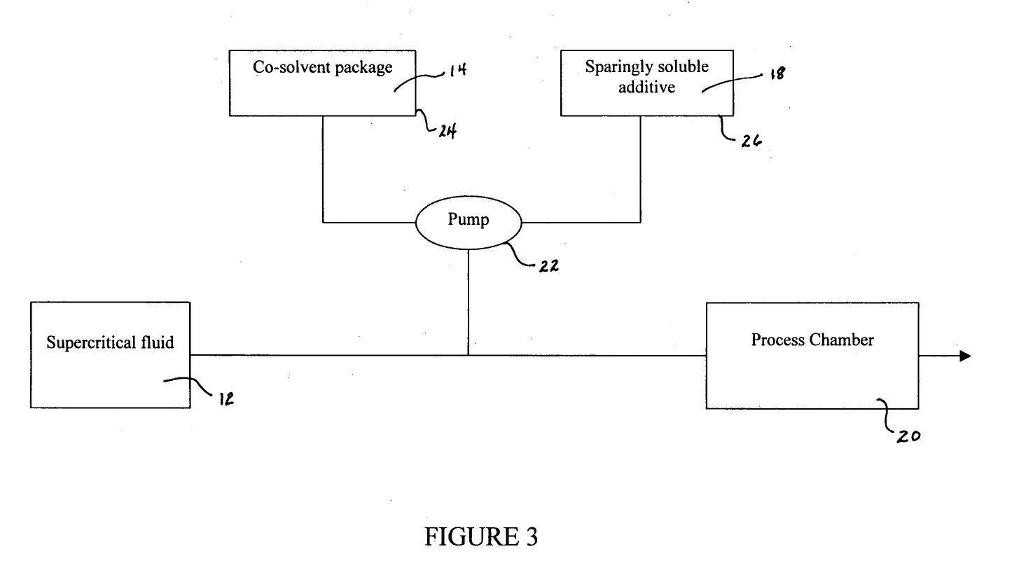

In one embodiment, the composition of the fluid entering the processing region can be varied continuously in composition in a manner that is optimizable with respect to the desired process outcome. As illustrated in FIG. 3, an alternative apparatus may be employed wherein a single pump 22 may be coupled to first and second reservoirs 24, 26. The first reservoir 24 containing a co-solvent package 14, the second reservoir containing an additive 18, insoluble or having limited solubility in the supercritical fluid 12. The pump can then continuously vary the composition of the co-solvent package as it is injected into the supercritical solvent flow line. Initially, a quantity of only co-solvent 14 may be introduced without additive 18. Based on pre-calculated mathematical models of concentration, empirical observation, or from feedback from concentration sensors within the process chamber, the additive is then introduced in such a way as to avoid precipitation. The additive 18 may be introduced gradually to the co-solvent/supercritical fluid flow, gradually replacing the co-solvent package 14 that is free of additive 18. As the additive package 18 contains at least one co-solvent, the concentration of co-solvents is kept constant within the system. Alternatively, the additive concentration in the system may be raised rapidly once the co-solvent concentration had reached the desired process level.

One skilled in the art will appreciate that alternative embodiments may be within the scope of the present invention and employ numerous additives or co-solvents. Any number of components might be present in the mixture, so long as the components do not interfere with the solubility of other components. When selecting components of the mixture a number of factors may be considered, examples include, but are not limited to, ease of use, environmental impact, cost, and efficacy.

The introduction of additives to a pre-saturated system affords number of benefits. The simplicity of the process avoids costly and complicated chemical processes and equipment to ensure that the additives remain in solution, which must otherwise be employed. The introduction of co-solvent prior to the introduction of sparingly soluble or insoluble additives alleviates the effect of the concentration gradient that forms between the co-solvent package. This gradient effect is most significant in large volume applications. Thus the pre-saturation method facilitates larger volume production.

Another embodiment of the present invention provides a method of processing an intermetallic or oxide dielectric film to remove debris from its surface. In this process, an organoammonium halide salt is used to etch and undercut the dielectric layer in the vicinity of the particles of debris on the surface, thus releasing them into the process fluid for removal. Although the salt is stable in dissolved phase with the Cosolvent methanol in carbon dioxide, the initial concentration of methanol in the vicinity of the dielectric surface is not enough to support continuous salvation of the salt. To prevent the precipitation of the salt in the processing chamber, a solution of methanol in carbon dioxide is first admitted into the chamber, thus preparing the composition in the chamber to support the cleaning process without precipitation of the salt. In these terms, the fluid in the chamber is presaturated with methanol to support subsequent introduction of the methanolic salt solution in carbon dioxide.

According to such embodiment, an acid ammonium salt is desired to be present in a methanol/CO₂ solution to effect an etching process of a metal from a silicon substrate. The ammonium salt is insoluble in CO₂ (sc) with less than 10% mole fraction methanol present. The introduction of a solution of the ammonium salt in methanol into a flow of supercritical carbon dioxide would initially result in a precipitation of the salt. At the point where the solution and the carbon dioxide meet, the mole fraction of methanol to CO₂ is not 10%, but approaches 0%, resulting in the precipitation of the salt. This effect is not overcome until an effective concentration of methanol to CO₂ is attained. To prevent this, methanol is added to CO₂ without the salt dissolved in it, resulting in a 10% methanol solution in supercritical CO₂. The salt solution may then be added. This prevents the precipitation of the salt, because it never encounters environs where the concentration of methanol is below the concentration at which the salt is soluble. Processing with the salt is then easily accomplished.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A method for the introduction of at least one additive to a processes chamber, said method comprising:
supplying a process fluid to said process chamber;
introducing at least one co-solvent to said process fluid thereby forming a mixture of said process fluid and said co-solvent, said additive being excluded from said co-solvent package;
allowing a concentration of said co-solvent relative to the process fluid at least within said process chamber to reach a level at which said sparingly soluble additive is soluble; and
adding a solution of said additive to said mixture of said process fluid and said co-solvent.

2. The method according to claim 1 wherein said additive comprises at least one additive selected from the group consisting of organo-quaternary ammonium halides, organo-quaternary ammonium psuedo halides, acidic aluminum salts, polar compounds, liquid ionic compounds, organic salts and inorganic salts.

3. The method according to claim 1 wherein said co-solvent is a low molecular weight hydrocarbon miscible with carbon dioxide

4. The method according to claim 1 wherein said co-solvent is at least one hydrocarbon selected from the group of hydrocarbons consisting of methanol, ethanol, isopropanol, Butanol, and short chain organohydroxy compounds.

5. The method according to claim 1 wherein said process fluid is selected from the group of process fluids consisting of carbon dioxide, Argon, sulfur hexafluoride, and combinations thereof.

6. The method according to claim 5 wherein said process fluid is a fluid in a supercritical phase.

7. A system for maintaining a solution of a sparingly soluble additive in a solution, said system comprising:
a supercritical solvent source;
a line communicating between said supercritical solvent source and a process chamber;
a source of a first co-solvent communicating with said line;
a source of said sparingly soluble additive;
a mixer disposed in said line.

8. The system of claim 7 wherein said mixer is a static mixer.

9. The system of claim 7 wherein said mixer is a dynamic mixer.

10. The system of claim 7 further comprises a pump.

11. The system of claim 10 further comprises a computer whereby said pump is controlled.

12. The system according to claim 10 wherein said computer communicates with a plurality of concentration sensors disposed in said line and/or said process chamber.

13. The system according to claims 10 wherein said computer executes a pre-calculated mathematical model governing concentration of said co-solvent.

14. The system according to claim 7 wherein said source of sparingly soluble additive further comprises a source of a second co-solvent.

15. The system according to claim 14 wherein said second co-solvent comprises said first co-solvent.
